(19) United States
(12) Patent Application Publication
(10) Pub. No.: US 2008/0079695 A1
(43) Pub. Date: Apr. 3, 2008

(54) Method and Program for a Personalized Mouse

(76) Inventors: Nicholas Martin, New York, NY (US); Nirav Amin, New York, NY (US); Russell Paul Blaise, New York, NY (US)

Correspondence Address: Nicholas Martin;Apt 4C, 460 2nd Ave., New York, NY, 10016, US

(21) Appl. No.: 11/538,373

(22) Filed: Oct. 3, 2006

(51) Int. Cl. G09G 5/08

(52) U.S. Cl. 345/163

(57) ABSTRACT

A personalized computer mouse controls activity on a computer display by selecting from a plurality of windows a predetermined window and designating the predetermined window as a default window. The windows that are not designated are set as miscellaneous windows. A mouse button is designated to correspond to the default window from a plurality of mouse buttons situated on the mouse. When the mouse button is depressed, simultaneous actions between the miscellaneous windows and default window occur.

### FIELD OF THE INVENTION

The present invention relates to a computer peripheral device interacting with an operating system and controlling the display. More particularly, a computer mouse that controls the windows that are opened on a computer display.

### BACKGROUND OF THE INVENTION

There are a variety of known computer input devices. The recent development and increased use of graphical user interface products, however, have served to highlight the inherent limitations of the conventional computer keyboard as an input device. For example, the conventional keyboard is designed primarily for textual input and allows limited control of cursor movements and data input flexibility. Unfortunately, data input and cursor control of such a limited nature often fails to take full advantage of the wide range of graphical functions provided in current graphical user interface products and thus frustrates the efficient and effective use of such products.

The functional and operational limitations of a conventional keyboard as a computer input device led to the development of alternative, more graphically oriented and user friendly computer input devices such as the joystick, mouse and trackball. Such alternative input devices require less direct attention (for example, eye contact) thus allowing the user to concentrate on the computer screen and the task at hand. These devices are specially designed to facilitate precision cursor movements, at varying speeds, and in virtually any desired direction, thus allowing the user to easily take full advantage of the enhanced graphical functions provided in current graphical user interface products.

However, common graphically oriented computer input devices typically retain an important limitation which is not present in the conventional computer keyboard: the inability to efficiently, and effectively, input the wide selection of user selected data that is many times requested and used in a repetitious manner in the data input fields of many graphical user interface products without depending on a secondary data input device, such as the conventional keyboard. For example, most current mouse devices are not large enough to have defined keys used for typing said data; and if did, would make the mouse device too large and impractical.

Typically, a user interacts with a computer system using a combination of a keyboard and a mouse. In a two-button mouse, user interface functions include mouse movement, left button down, left button up, right button down and right button up. With each mouse movement, current X-Y coordinates of a corresponding mouse cursor are reported.

A mouse click is defined as a sequence of button down event followed by button up event. Moving the mouse (or an associated cursor) without either button being activated is sometimes referred to as hover. Hover is an important user interface capability for many applications where passing the mouse cursor over an object (e.g., an icon) may cause additional information (hovering information) to be displayed, for example, in a pop up window.

The ability to achieve all of the functions of a mouse (e.g., both left and right button up and down events, etc.) has been a subject of many research efforts. There are sophisticated and significantly expensive touch screen systems available on the market today using styluses that include electronics or styluses that generate electrical signals. Such systems are often expensive to implement.

### SUMMARY OF INVENTION

It is therefore an object of the present invention to provide a novel computer peripheral device interaction method and program to control a computer display.

The current invention is a personalized computer mouse which controls activity on a computer display, via selecting from a plurality of windows a predetermined window, designating the predetermined window as a default window, designating the plurality of windows not designated as the default window as miscellaneous windows, and designating a mouse button to correspond to said default window from a plurality of mouse buttons situated on the mouse. The values are of the mouse button, default window and miscellaneous windows are stored in a memory of the computing device. When the mouse button is depressed, simultaneous actions between the miscellaneous windows and the default window occur.

As an embodiment of the present invention, the disclosed mouse is formed in such a way as to include a plurality of front mounted, either or both mounted buttons and a scroll dial/button. The invention is a mouse having the standard features available on conventional mice known in the prior art, including main top mounted buttons, wheels, roller-balls, and the like. The frontal buttons are mounted in such a way as to provide for easy access by the operator. The function of the front buttons is to allow for the use of specialized software developed for this purpose.

As an embodiment of the present invention, actions are assigned pertaining to miscellaneous and default windows as functions of depressing the mouse button. When depression occurs, the miscellaneous windows are minimized or closed on the computer display. If said default window is currently minimized when said mouse button is depressed, said default window is maximized on the computer display. If said default window is currently in the background of the computer display when said mouse button is depressed, said default window is brought to the front of the computer display. If said default window is closed, a new window which would display said default window is opened on the computer display.

As an embodiment of the present invention, when said mouse button is depressed twice, said activity is designated wherein, said activity is set to perform one of the following: restore the computer display to an original display prior to first depression, minimize both the miscellaneous windows and the default window, and close all windows. Each odd numbered depression coincides with the first depression of said mouse button.

Other objectives and advantages of the present invention will become obvious to the reader and it is intended that these objectives and advantages are within the scope of the present invention.

To accomplish the above and related objectives, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective from above displaying mouse buttons and roller.

FIG. 2 is a left side elevational view, the right side elevational view being a mirror image thereof; a perspective from the side displaying the option of additional buttons on a side of a mouse.

FIG. 3 is a flowchart depicting personalizing the mouse for depressions.

FIG. 4 is a flowchart depicting how the personalized mouse controls a computer display.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. In addition, the improved desktop mouse as taught herein can be shaped into different appearances including different buttons, different number of buttons, and different button locations. In addition, it is to be understood that the phraseology and terminology employed herein are for the purpose of the description and should not be regarded as limiting. Furthermore, as will be apparent to those skilled in the art, the present invention may be embodied in other specific forms without departing from the essential characteristics thereof. For example, the button could be on a track ball, joy stick, game pad or other device, not just a mouse.

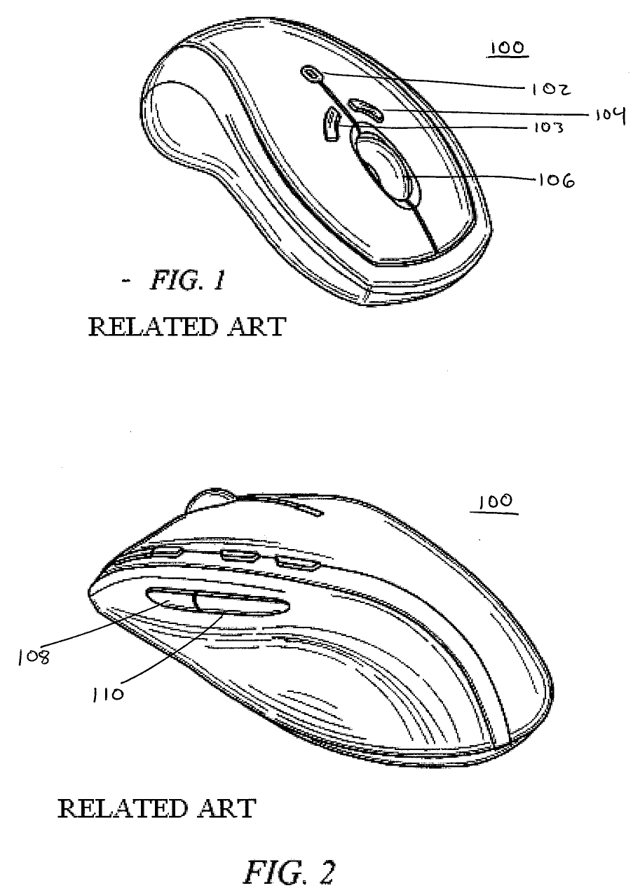

FIG. 1 is a perspective view of a mouse according to what is well known in the art. In an embodiment, the mouse 100 has a top housing, which has three extending buttons 102, 103 and 104, which are situated on the top portion of the mouse 100. A scroll button 106 also appears on the top portion of the mouse 100. The scroll button 106 can perform the functions well known in the art of either scrolling through a screen and/or as a button to select/deselect items on a screen.

FIG. 2 is another perspective view of a mouse according to what is well known in the art. In an embodiment, the mouse 100 has a top housing, which has two buttons 108 and 110, which are situated on either one or both side portions of the mouse 100.

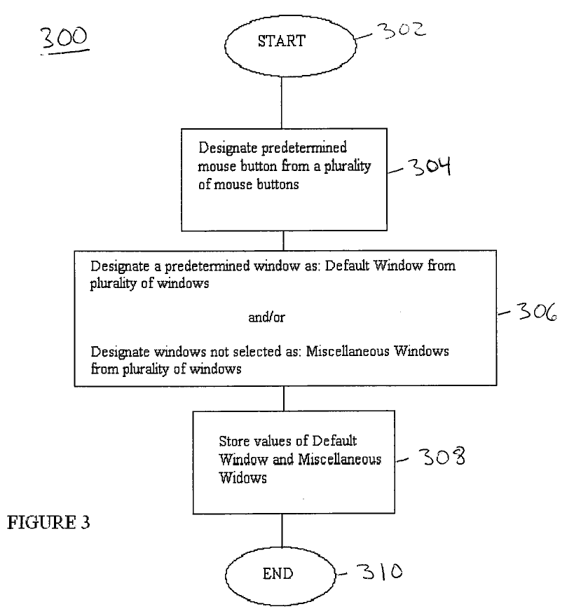

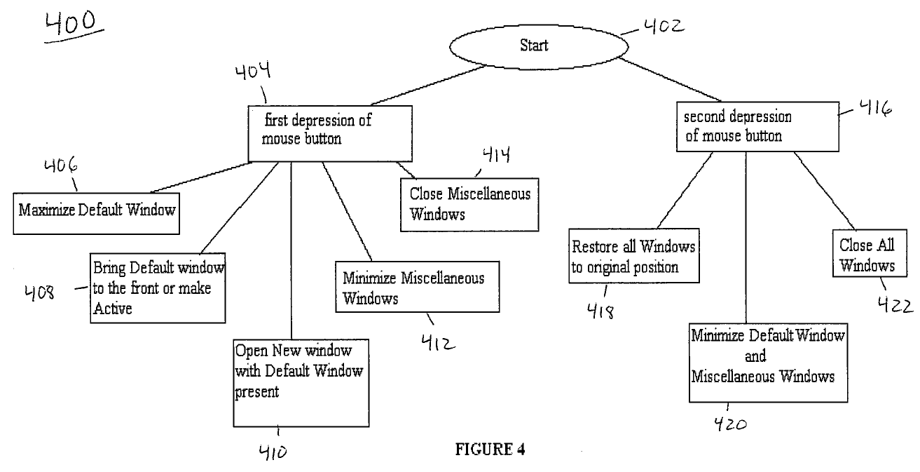

FIG. 3 depicts personalizing the mouse for depressions. At first, the Start 302, a plurality of mouse buttons and plurality of windows must be selected and/or designated. The order of designating the mouse button and window(s) can be of any order. For example purposes and to correspond to FIG. 3, the mouse button will be designated first. From the plurality of mouse buttons, a predetermined mouse button 304 is designated. The predetermined mouse button acts as the catalyst upon depression(s) as to which screens will be open, closed or minimized, as discussing in FIG. 4. Step 306 shows that from the plurality of windows, a predetermined window is selected, which is subsequently designated as the Default window and/or from the plurality of windows, Miscellaneous windows will be designated. This Default window is the window that will be either maximized, restored or opened, depending on the situation, for a mouse depression, as discussed below. The designated Miscellaneous windows are the remaining windows that are not designated as the Default window. Further to step 306, if a Default window is designated, it can be seen that the remaining Miscellaneous windows need not be designated through an extra step.

After the designation of the predetermined mouse button 304 and Default window and/or the Miscellaneous windows 306, there values are stored in memory of a computer, as shown in step 308. This storing procedure provides faster access to the designated values in contrast to storing the values on the mouse. Overall, the process ends with at step 310.

FIG. 4 depicts how the mouse 100 controls a computer display after the actions of a first depression 404 and a second depression 420 of the predetermined mouse button 316. After the first depression 404, the Default window (identified as element 306 in FIG. 3) has options to be set to a number of actions. If the Default window has been minimized prior to the first depression 404, then the Default window can be set to be maximized 406. If the Default window is in the background of a computer screen prior to the first depression 404, then the Default window can be set to be brought to the front/made Active 408. If the Default window is not open prior to the first depression 404, then a new window with the Default window present can be set to be open 410.

Substantially simultaneously along with the Default window actions of 406, 408 or 410, Miscellaneous window actions occur after a first depression 404 of the predetermined mouse button 316. If the Miscellaneous windows (identified as element 308 in FIG. 3) are maximized/active prior to the first depression 404, then Miscellaneous windows can be set to be minimized 412. Furthermore, the Miscellaneous windows can be set to be closed 414 after a first depression 404.

After the second depression 416, the plurality of windows, which comprises the Default window and the Miscellaneous windows, can be set to be restored 418 to their original position, completely minimized 420 to show the desktop of a computer display or to close all the windows 422.

As described above, all the steps are processed in connection with a mouse and computer as a program, recorded on a computer-readable medium, can execute accordingly.

While illustrative embodiments of the invention have been described above, it is, of course, understood that various modifications will be apparent to those of ordinary skill in the art. Such modifications are within the spirit and scope of the invention, which is limited and defined only by the appended claims.

What is claimed is:

1. A method for personalizing computer mouse activity, comprising:
designating a predetermined window from a plurality of windows;
designating a mouse button from a plurality of mouse buttons that performs an action when operated; and
wherein the action causes the predetermined window to become an active window and substantially simultaneously, the action further causes the remaining windows to minimize or close.

2. The method as claimed in claim 1, further comprising:
designating the remaining windows as miscellaneous windows,
wherein one or more of said remaining windows closes, and
wherein one or more of said remaining windows is minimized.

3. The method as clamed in claim 1,
wherein if the predetermined window is currently minimized when said mouse button is operated, said predetermined window is maximized,
wherein if said predetermined window is currently in the background of a computer display when said mouse button is depressed, said predetermined window is brought to the front of the computer display, and
wherein if said predetermined window is closed, a new window which would display said predetermined window is opened.

4. The method as claimed in claim 1, further comprising:
designating said activity when said mouse button is depressed twice,
wherein, said activity is set to perform one of the following:
restore the computer display to an original display prior to first depression,
minimize all windows, and
close all windows.

5. A program, recorded in a computer readable medium, for personalizing computer mouse activity, said program comprising the steps:
designating a predetermined window from a plurality of windows;
designating a mouse button from a plurality of mouse buttons that performs an action when operated; and
wherein the action causes the predetermined window to become an active window and substantially simultaneously, the action further causes the remaining windows to minimize or close.

6. The program as claimed in claim 5, further comprising the step:
designating the remaining windows as miscellaneous windows,
wherein one or more of said remaining windows closes, and
wherein one or more of said remaining windows is minimized.

7. The program as clamed in claim 5,
wherein if the predetermined window is currently minimized when said mouse button is operated, said predetermined window is maximized,
wherein if said predetermined window is currently in the background of a computer display when said mouse button is depressed, said predetermined window is brought to the front of the computer display, and
wherein if said predetermined window is closed, a new window which would display said predetermined window is opened.

8. The program as claimed in claim 5, further comprising the step:
designating said activity when said mouse button is depressed twice,
wherein, said activity is set to perform one of the following:
restore the computer display to an original display prior to first depression,
minimize all windows, and
close all windows.
